(19) United States
(12) Patent Application Publication
(10) Pub. No.: US 2008/0052146 A1
(43) Pub. Date: Feb. 28, 2008

(54) PROJECT MANAGEMENT SYSTEM

(76) Inventors: David Messinger, West Hartford, CT (US); Javier Fernandez-Ivern, Rocky Hill, CT (US); John M. Hughes, Hebron, CT (US); Robert Hughes, Marlborough, CT (US); Lorie Ilene Norman, Hiltons, VA (US); Anthony Jefts, Warwick, RI (US)

Correspondence Address: Goodwin Procter LLP, Patent Administrator, 53 State Street, Boston, MA, 02109-2881, US

(21) Appl. No.: 11/755,909

(22) Filed: May 31, 2007

Related U.S. Application Data
(63) Continuation-in-part of application No. 11/415,392, filed on May 1, 2006.
(60) Provisional application No. 60/809,721, filed on May 31, 2006.

(51) Int. Cl. G06Q 10/00; G06F 17/40

(52) U.S. Cl. 705/9

(57) ABSTRACT

A production contest management system enables management of workflow and scoring of projects, for example in a production contest environment. A project is divided into “phases.” Project managers can specify project phases, and for each phase, required timing and deliverables. For phases that involve a review (e.g., screening, review board, peer review), scorecards used to perform the review may be specified. The scorecards are made accessible electronically to one or more reviewers. The scorecards may be available on-line, or may be downloaded, completed, and then uploaded. Once received, scorecards are tallied. In this way, the management system helps coordinate production of a product that is produced using production competitions. The system allows for simultaneous management of multiple projects and production teams.

### PRIORITY

This application claims priority to, and the benefit of, U.S. Provisional Patent Application Ser. No. 60/809,721, filed May 31, 2006, entitled “PROJECT MANAGEMENT SYSTEM,” attorney docket number TOP-008PR, incorporated herein by reference. This application also claims the benefit of co-pending U.S. patent application Ser. No. 11/415,392, filed May 1, 2006, entitled “SYSTEMS AND METHODS FOR SCREENING SUBMISSIONS IN PRODUCTION COMPETITIONS,” incorporated herein by reference.

### FIELD

The invention relates to project management tools, and more particularly, to computer-based tools for managing projects.

### BACKGROUND

Tools such as MICROSOFT PROJECT are available to help a project manager track and display information about projects. Convention tools do not have facilities for managing contest-based projects or other projects that involve a phased, rigorous development methodology.

### SUMMARY

A production contest management system enables management of workflow and scoring of projects, for example in a production contest environment. A project is divided into “phases.” Project managers can specify project phases, and for each phase, required timing and deliverables. For phases that involve a review (e.g., screening, review board, peer review), scorecards used to perform the review may be specified. The scorecards are made accessible electronically to one or more reviewers. The scorecards may be available on-line, or may be downloaded, completed, and then uploaded. Once received, scorecards are tallied. In this way, the management system helps coordinate production of a product that is produced using production competitions. The system allows for simultaneous management of multiple projects and production teams.

The flexibility of the management system allows it to be useful in the production of a variety of products and methodologies. The management system generally is applicable to production that is reviewed and scored. For example, it may be used with any sort of project that is developed using production competitions. It also may be used with any other sort of project that provides for review of production, particularly if the review is conducted such that the reviewer does not know the identity of the participant under review until after the review is conducted.

The management system provides the capability to have multiple projects that use the same methodology and/or have a customized methodology for some projects or group of projects. Template projects may be used as the starting point for specifying the methodology for a project. For example, a component development project may have an initial configuration of phases and timeline. Such a project may serve as a template for modification based on the goals of the project and the anticipated timeline.

In some embodiments, a project typically includes a number of different phases (e.g., submission, screening, review) as described further below. For each phase, deliverables may be specified. The management system coordinates the activities of the participants (e.g., project manager, submitter, screener, reviewer, aggregator, final reviewer, approver, observer, public, designer). Depending on their role, participants may have access to, or the requirement to generate, certain deliverables.

Once a project is specified, it may run automatically, with the management system changing the phase when specified conditions occur. Thus, phases may start and/or end automatically or manually. Each phase may start at a particular time and/or upon the completion of a previous phase and/or upon other preconfigured conditions and/or upon manual intervention. Project managers may configure phases that are included conditionally in a project depending on the results of other phases. In one embodiment, a project manager may add, remove, or configure phases at any time, even while production is underway.

Work on a project may take place in multiple phases at the same time. For example, screeners may process submissions upon receipt, even before the submission phase ends. In one such embodiment, the screening phase can not end until the submission phase ends.

Users with appropriate permissions may view the status of phases and scoring results, as well as other data. For example, views may be provided that are project-specific, client-specific and/or look across multiple clients. A view can show the results of online review of all phases for all projects. It also can show outstanding deliverables by person and project.

Scoring may take into account the assignment of penalties. For example, if a developer misses a deliverable, or delivers a deliverable after a specified deadline, there may be a penalty. Penalties may be levied automatically or manually.

In one embodiment, the system allows for configurable phases in which additional parties can participate in review. For example, a phase and related scorecard can be added for a particular type of review. This may allow a requester of produced work product (e.g., a client, in-house team, etc.) to participate in review. Likewise, it may allow a third-party (e.g., consultant, expert, government representative, etc.) to review work product.

As a demonstrative example, there may be a Sarbanes Oxley scorecard that allows a compliance officer or expert to review work product (e.g., software specification or code) for Sarbanes Oxley compliance. Likewise, there may be a security scorecard, that allows a security officer or expert to review work product for risk assessment and security vulnerabilities.

There may be any number of scorecards, and there may be specific scorecards for some projects. For example, there may be a mobile device-specific scorecard that allows review of criteria that is specific to a mobile telephone environment, such as footprint, ability to operate with call interruption, and so on.

The management system may track which scorecards were used for what production, and allow for the development of metrics around the results of their use. For example, the methodology may be modified and/or scorecards adjusted, based on quality assurance or other statistics associated with a particular scorecard or methodology, and the resulting production.

As mentioned above, conditions may be specified for the start/end of a particular phase. (e.g., a prerequisite for “Final Review” phase may be that “Final Fixes” are complete; “Screening” phase may not be complete until all submissions have been screened”). In one embodiment, information about the participants or the results of the process may be used to control the parameters of the phases. For example, a participant's ratings could be used to control the phases, such as a Submission phase and/or a Screening phase.

In one such embodiment, a submission phase may be ended based on ratings of those that submit e.g., one highly rated participant (e.g. a “red” contestant) and any other participant. The rating of the submitter(s) is used as an indication of confidence that at least one submission is a good submission. In one such embodiment, a reliability factor may be determined based on the participants who submit, and if the reliability factor is higher than a predetermined threshold, a Submission phase is ended. In one embodiment, the submissions are screened automatically, and an evaluation of the reliability factor is made based on the submitters who submitted submissions that pass automatic screening.

In one embodiment, if a phase ends earlier than expected because specified criteria have been met, the timeline will be recalculated. This will allow for faster completion of a project.

In one embodiment, a production contest is conducted in which there is no registration phase, and the length of the submission phase is based on the submissions received that pass screening and the ratings of their submitters. In this embodiment, resubmission by a participant after the participant's first submission has passed screening is not allowed, so as to prevent participants from submitting incomplete submissions for review.

In one embodiment, attributes of phases (e.g., duration, work effort, etc.) may be configured based on the supply of labor, ratings of participants, backgrounds of participants, client involvement in the process and/or other factors.

In general, in one aspect, a method for conducting a production competition includes facilitating creation of a scorecard comprising questions and question types. The method includes storing the created scorecard. The method includes facilitating specification of a review phase, the review phase configured to require completion of the created scorecard. The method includes facilitating specification of a project, the project configured to include the specified phase, receiving submissions from submitters, and upon receipt of some number of the submissions, making the scorecards available electronically to reviewers for completion during the review phase.

In general, in another aspect, a method for managing a project, includes facilitating selection of a template for a project, the template comprising a number of project phases, the project phases comprising a submission phase and a review phase. The method includes receiving configuration for the phases of the project, the configuration comprising specifying a start time for a first phase of the project and adding a second review phase to the project. The method also includes automatically starting the project at the start time of the first phase of the project, and providing to users the status of the project upon request. The method also includes automatically starting the added phase when previous phases have completed.

In general, the project may be a production contest, for example for the production of a software application and/or a software component. For example, the project may be for development of a software application that includes multiple components. The method may include receiving submissions from users. The step of providing status may include providing information about deliverables due. During the review phase, the method may include facilitating the completion of scorecards. This may be accomplished “on-line” such that the scorecards are provided and completed while a user's browser is connected to the management system via a computer network and/or this may be accomplished “off-line” by transmitting scorecards to a users' computer, having the completed on the users' computer (even, perhaps, while the user is not in communication with the management system over the network), and receiving scorecard(s) from the users' computer. In one embodiment, during the added phase, completion of scorecards is facilitated.

### BRIEF DESCRIPTION OF THE DRAWINGS

FIG. 1 is a flowchart of a project in an embodiment of the invention.

FIG. 2 is an exemplary display of an interface to create a project in an embodiment of the invention.

FIG. 3 is additional display from the interface of FIG. 3.

FIG. 4 is an exemplary display of a project list according to an embodiment of the invention.

FIG. 5 is an exemplary display of a project display according to an embodiment of the invention.

FIG. 6 is a block diagram of an embodiment of the invention.

FIG. 7 is a block diagram of an embodiment of the invention.

### DETAILED DESCRIPTION

While previous systems may have been used to manage various different types of projects, or one specific type of contest, the disclosed management system allows for production of different types of work product by providing for management of a flexible, review-based process. For example, although suitable for use in a typical component development competition, the management system allows for configuration of a variety of additional project types, multiple scorecards per project, optional phases (e.g., submission) and custom review phases (e.g., client review). Project managers have the ability to set multiple default scorecards per project phase and create client or application-specific scorecards. Scorecards may be created for various project types including, for example, applications, assembly, testing as well as component development. At the same time, project participants may easily and quickly perform reviews, and see a consistent interface for all project participants to use while participating in project development.

A page may be provided that displays each project phase, and also provides the ability for users to view the projects with which they are associated. For example, project managers, clients, and architects may view project status and timelines for all project types. For example, a user may access the system, provide identification information, request projects, and view projects to which they have been assigned and/or expressed interest.

In one embodiment, when project timelines are displayed, the GUI provides an indication of phase dependencies in the timeline display itself. The GUI for the project list indicates when projects are nearing their due date or behind schedule. For example projects that are near their due date could be displayed in yellow and projects that are past their due date could be displayed in red. Likewise, the GUI for timeline phases indicates when phases are behind schedule. For example phases that are near their due date could be displayed in yellow and phases that are past their due date could be displayed in red.

In one embodiment, a Graphical User Interface to the management system is provided as a series of JSP pages that can be viewed with a browser, such as Internet Explorer and Mozilla Firefox. Standard protocols, such as HTTP for non-secure communication and HTTPS for secure communication are used to communicate between the browser and the application running on a server. Database connectivity is provided via JDBC. SMTP may be used to send email from the application. The system may be implemented on one or more server-class computers, that support and/or include web servers, application servers, and database servers.

In some embodiments, reviewers are able to login, check the status of their assignments, download submissions for review, complete online review forms and perform aggregation of reviews. An administration section allows users to set up reviews, assign members, monitor the process and intervene at any stage of development. The disclosed technology may be used, for example, by any organization that undertakes a production project using a reviewed production process.

Generally speaking, in the context of an embodiment of a management system, a project may be described as a set of phases that each may have associated submissions and deliverables. A phase is the state of an active project at any given time. A project generally is in only one phase at a time, although it may be possible for work associated with two phases to go on simultaneously. Some projects require submissions, which are reviewed in a scorecard review process. Deliverables are items that are delivered before a project advances from one phase to the next, and may include submissions, reviews of submissions, aggregations of reviews, and other items.

In one exemplary embodiment, the management system may be used to manage the development of a software component by production contest. This is described, for example, in co-owned and co-pending U.S. patent application Ser. No. 11/035,783, entitled SYSTEMS AND METHODS FOR SOFTWARE DEVELOPMENT, filed Jan. 14, 2005. Such a production contest involves a number of phases.

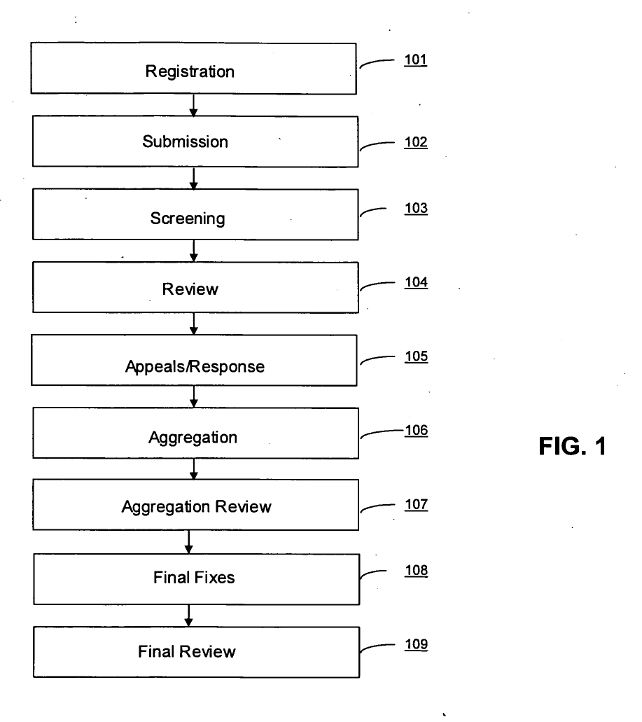

Referring to FIG. 1, as a demonstrative example of an embodiment, a software component to be developed is announced to potential contestants, and some number of contestants register for a production contest. The registration takes place in a Registration phase 101. A registration may be an indication that the participant will participate in the production contest, and may include additional, or other information. In this example, the deliverables for a Registration phase are participant registrations for the production contest.

Information about work product to be generated by registered participants may be provided to them before and/or after they register. In general, the information about the work product should be clear enough so that participants can reasonably determine whether they will be able to generate the required work product.

In this example, a registration phase 101 is followed by a submission phase 102. During the submission phase 102, the participants generate and submit work product. In this example, the work product may be included in submissions to a contest for development of a software component, with the best work product identified in a structured evaluation. Prizes may be awarded to the best, and in some cases, to runner-up submissions. When work product is generated, it is submitted to the management system. The management system stores the submissions, and notifies the appropriate participants of the submission. The deliverables for the submission phase 102 are the participant's submissions.

In this example, there is screening 103 of submissions. Screening may take place at the completion of the submission period, and/or upon receipt of a submission to verify that the submission meets predetermined requirements. Screening may be automatic or manual. Typically, submission requirements that are evaluated by a automated screening system are formal requirements that are verifiable by an automated tool. For example, the predetermined requirements may state that particular file names, file types, and directory structures be used. The predetermined requirements may address the names and formatting of the content of individual content files. The predetermined requirements may include other requirements, such as adherence to certain interfaces or standards, or that the submission pass review by an automated tool, such as a compiler. For each requirement, alone or in combination, an automatic screening system can automatically check for adherence of the submission to the requirements. Such an automated screening tool is described in co-pending U.S. patent application Ser. No. 11/415,392, filed May 1, 2006, entitled “SYSTEMS AND METHODS FOR SCREENING SUBMISSIONS IN PRODUCTION COMPETITIONS.”

In one embodiment, the screening involves completion of scorecards, and the deliverables for the screening phase 103 are completed scorecards for each submission. Some or all of the screening scorecard may be completed automatically by an automated tool. If there is any manual screening, for example, manual inspection of the submission, a screener will perform the inspection, and at the same time review the results of any automatic screening. The screener completes a scorecard for the submission. After completion of the screening scorecard by the screener, the total points awarded on the screening scorecard may be determined by the management system, and a determination made about whether the submission passes the screening process.

If the submission passes the screening phase 103, the submission will be further reviewed in a review phase 104. If the submission does not pass the screening phase 103, depending on the timing and the rules, the participant may be able to resubmit the submission.

The submissions may be reviewed more substantively in a review phase 104. In one embodiment, the review process may be any sort of review, but is driven by one or more sets of review scorecards. There may be one, two, three, or more reviewers associated with the review phase 104, and the reviewers may complete the same or sections or different sections of a scorecard associated with a phase. In general, the scorecards may be configured so that the reviewers each provide overlapping feedback with respect to some criteria, and look at and/or consider different criteria as well. Depending on the type of work product, the intended use of the work product, and so on, there may be any number of different types of reviews and scorecards. In general, it is helpful if the criteria for review are clear to the participants from the beginning, so that they understand the basis for the review and scoring. In this example, deliverables for the review phase 104 are completed review scorecards for each of the submissions that passed screening from each of the specified reviewers. If, for example, one or more of the reviewers (e.g., failure, stress and accuracy reviewers) is required to develop test cases for the work product, the deliverables may include the test cases to be provided by that reviewer. In one embodiment, the criteria are described in the rules for the production competition.

Any suitable scorecard questions may be used on the various scorecards. Scorecards may include, for example, questions that are Yes/No questions, or on a 1-4 scale or a 1-10 scale. In each case, in designing questions, it is useful to make the scorecard easy to complete, but also allow enough scoring granularity to make appropriate distinctions among participants.

Following the review phase, in this example, is an appeals phase 105. Participants can view their reviews, and respond to comments made by the reviewers. The appeals process may be useful to help reviewers understand decisions made by a participant that may not be immediately apparent. Appeals are made by participants inserting comments into scorecards, which may then be revisited by reviewers. Included in this phase is a response by the reviewers to the appeals. Thus each reviewer looks at the appeals, and makes changes, or decides not to make changes, to the review in response to the appeal. Thus, in this example, deliverables for this phase include the appeals (if any) from each participant, and a response to each appeal from the appropriate reviewer. It should be understood that the appeals portion and the appeals response portions may be implemented as one phase, or may be separated in other embodiments into a separate appeals phase and appeals response phase. After appeals and appeals response, the selection of the winner(s) and award of prizes also may be made.

After the appeals/response phase 105 may be an aggregation phase 106. An aggregation phase may involve reviewing and combining review scorecards (after appeals) into a combined score. Generally, this may involve elimination of duplicate comments, averaging scores for items reviewed by multiple reviewers, and totaling scores related to different criteria. The aggregation effort may be performed by one of the reviewers or by a different reviewer than in the review phase 104. The deliverables of the aggregation phase 106 may be aggregated scores for each of the participants. An aggregator also may aggregate comments from the reviewers into a list of final fixes for one or more of the winner(s). Final fixes are changes that identified in reviews that may be required or recommended prior to final review 109.

In this example, following the aggregation phase 106 is an aggregation review phase 107. One or more reviewers may review the work of the aggregator. Depending on whether the aggregator is an administrator or a participant, it may make sense to include an aggregation review phase 107 to review the work of the aggregator, to make sure that the decisions made were fair and appropriate. The aggregation phase 107 review may take place using scorecards configured to allow evaluation of the aggregation effort. In this example, deliverables for the aggregation review phase 107 are aggregation review scorecards for each submission that passed screening, and a list of final fixes for the winner(s). If the aggregation does not pass review, a new aggregation phase and a new aggregation review phase are added, so that the same or a different aggregator can complete the aggregation satisfactorily.

A final fix phase 108 allows the winner(s) to make the changes identified during aggregation. In one embodiment, the final fixes are identified on a checklist-style list, and then may be made by a participant. Deliverables for the final fix phase 108 is a revised submission from the participant. The final fix phase 108 may be screened or otherwise tested, as well as reviewed for completion of the final fixes.

In the final review phase 109, the final fixes are verified, and the work product is approved 110 for release. In this example, the deliverable for final review 109 is a completed final review scorecard, which may include the checklist of final fixes that were to have be made.

In the case of a software component, the approved software component may be provided to an end-user or customer, or may be provided in a catalog or library for use by others. An approval phase (not shown) may include final approval from an approver, to release the work product as complete.

In some embodiments, a management system manages the various phases of a contest-based development project and allows for the tracking of the various submissions and deliverables. It provides a facility for scorecards to be developed and completed, for scores to be tracked, winners awarded (if appropriate) and participants (e.g., submitters, screeners, reviewers, etc.) to be compensated for their efforts. In some such embodiments, a system for managing contest-based development projects comprises a submission receiving system, a scorecard development system, a scoring system for scoring received submissions using the scorecards, an award system for awarding a winner based on the scorecards, and a compensation award tracking system.

It should be understood that the example of the software component production by contest is exemplary, and one object of the management system is to provide a flexible platform that may be used in a variety of contexts in which contest production, or more generally, reviewed production, may be implemented in a phased approach. For example, an embodiment of a contest management system may provide some of the capabilities of a conventional project management system, with additional capabilities such as managing scorecards, facilitating review using the managed scorecards, managing receipt of deliverables, and automatic phase changes. Together, these enable efficient production of work product according to a development methodology.

Projects

Project managers can create new projects. (It should be generally understood that tasks attributed to project managers may also be performed by administrators and in some cases by others.)

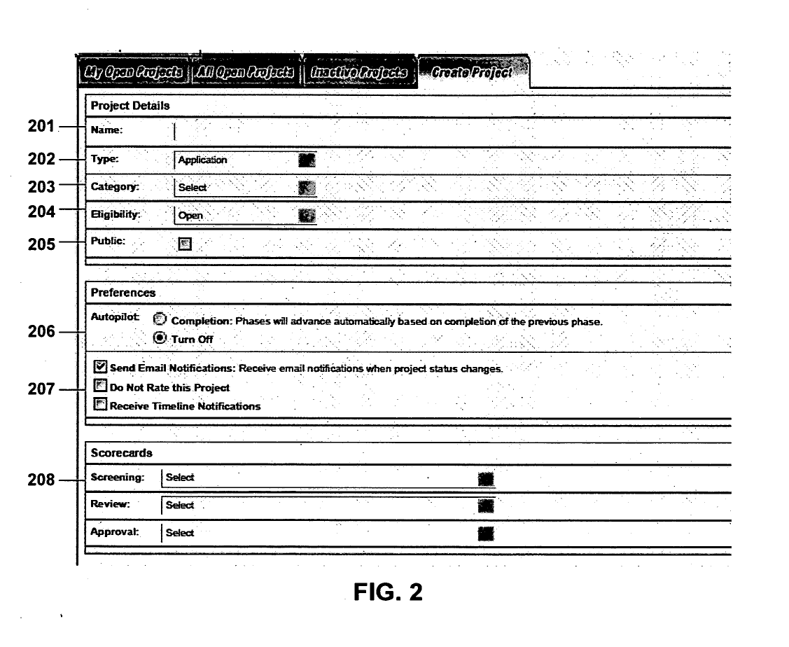

Referring to FIG. 2 as an exemplary new project interface, in one embodiment, projects are specified by their name 201, type 202 and category 203.

Exemplary project types include components and applications. For each of these project types, sub-types or categories may be specified. For component projects, for example, project categories may include, design, development, security, process, and/or testing. For application projects, project categories may include specification, architecture, component production, quality assurance, deployment, security, process, testing, and/or assembly. Additional project types and categories may be specified.

The project interface may include a specification of who is eligible for participation in a project 204, whether the project is accessible by the public or is private 205, whether an “auto pilot” feature is enabled 206, specification of notifications to provided upon changes to the project, and whether the project will be rated 207.

A choice of the scorecards to be used 208 may be selected. The phases that use scorecards 208 (in this example, Screening, Review, and Approval) and the scorecards that are available for selection may be determined by the configuration of the management system, and the project type 202 selected. For example, a Project Manager may select a particular screening scorecard for a screening phase, a review scorecard for a review phase, and an approval scorecard for a final review phase. In one embodiment, the administrator or project manager only can select active scorecards. If more than one instance of a phase exists (e.g., two review phases) a scorecard may be assigned to each phase. Likewise, some review phases may involve review with different scorecards. In one embodiment, there is one scorecard for each phase, but different sections of a scorecard for the phase may be completed by different participants.

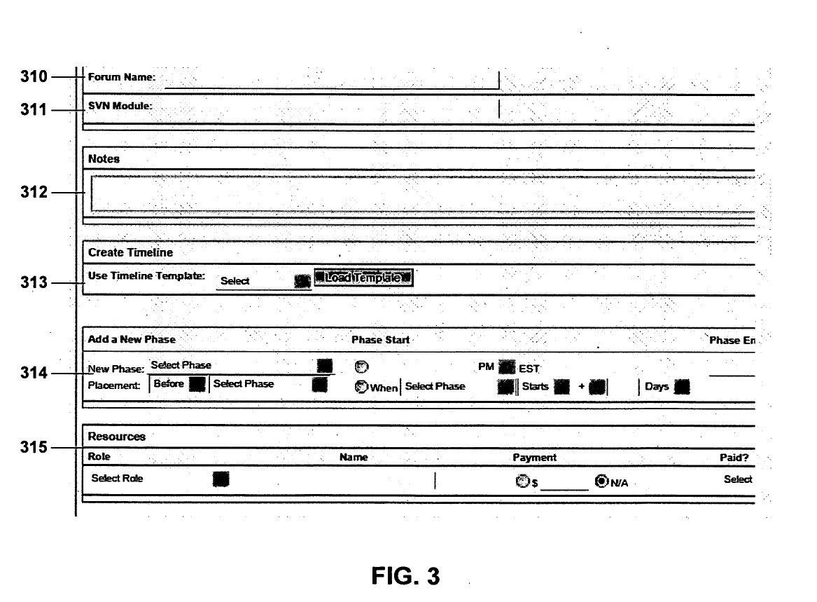

Referring to FIG. 3, configuration of a project also may include specifying a link to a project forum 310, a source code versioning (SVN) module name and/or location 311, and project notes 312. A project forum is a discussion board for communication with and among participants. Source code versioning may be used to stre code that has been developed. Project notes allow for collection and retention of information about a project. The configuration also may include specifying a timeline 313, which may begin, for example, with a date to begin registration. In one embodiment, a template timeline may be selected for a project, and the template then modified by deleting, editing, or adding 314 additional phases. For example, to schedule an additional review phase, an additional phase may be added to the project using the new phase data input 314. This will add an additional phase to a project.

In one embodiment, project managers can create and modify timelines for projects. Each project type has its own configurable template timeline, which can be edited. For example, each project may have a configurable default start date, which in one embodiment is 9 am the following Thursday for components, and the current date for applications. Each project may have configurable default phases.

For example, in some embodiments, a component competition includes phases of registration, submission, screening, review, appeals, appeals response, aggregation, aggregation review, final fix, and final review. As another example, an application project may omit the registration phase, and include submission, screening, review, appeals, appeals response, aggregation, aggregation review, final fix, and final review. If manual screening is required, one screening phase may appear in the timeline for each submission when auto-screening is complete. Thus, in some cases, different screening phases may take place simultaneously depending on when submissions are submitted. It also may be possible to include multiple component developments into an application, such that each of the components is part of the application development process.

These phases may have configurable default durations. For example, for the exemplary default component phases described above: the default for registration is 72 hours; the default for submission is 120 hours; the default for screening is 24 hours, the default for review is 24 hours, the default for appeals is 25 hours; the default for appeals response is 12 hours; the default for aggregation is 12 hours; the default for aggregation review is 24 hours; the default for final fix is 24 hours; and the default for final review is 24 hours. Likewise, for the exemplary default application phases described above, the default for submission is 24 hours; the default for screening is 24 hours; the default for review is 24 hours; the default for appeals is 24 hours; the default for appeals response is 24 hours; the default for aggregation is 24 hours; the default for final fix is 24 hours; and the default for final review is 24 hours. It should be understood that these default values are exemplary and that other suitable values may be used, depending on the locations of the participants, and their overall responsiveness.

In one embodiment, based on the phase start date and phase durations the start and end dates may be generated for each phase.

Configuration of a project also may include specifying desired participants (i.e., human resources) 315, by their role and compensation. Compensation may be money, points, prizes or any other sort of reward or combination that may be appropriate. Project managers may add, delete, or edit project resource details. For example, they may edit the role of a resource, the name of the resource, and the payment amount for the project resource, and the payment status. Once the roles for desired resources have been specified, qualified participants may commit to fulfill such roles. The system may facilitate the participant's subscription/assignment to a role. Roles may be specified for a phase and/or a project. There may be more than one of the same role for different phases of the same project. In one embodiment, the following roles are possible with the following rules: aggregator (one per aggregation phase); designer (one per project); final reviewer (one per final review phase); screener (one per submission) and/or primary screener (one per screening phase); submitter (one to many per project); reviewer (one to many per project); stress test reviewer (one per review phase, for component projects); failure test reviewer (one per review phase, for component projects); accuracy test reviewer (one per review phase, for component project); manager (one to many per project); observer (one to many per project); public (one to many per project); approver (one per approval phase).

For example, using the system, project mangers may assign primary screeners to a project. The primary screener will perform many or all of the screenings for a project. If there is a primary screener, the handle for the primary screener appears as the resource name for all individual screening roles.

After creation, project managers may edit project details by selecting a project for editing. This may be accomplished using an interface such as that shown in FIG. 2 and FIG. 3. For example, in one embodiment, details that may be edited include project notes, whether the project is “auto-pilot,” such that phases advance automatically based on deliverable completion, whether notifications are sent when the project is edited, whether project participants are to be rated for this project, and whether the project has sent or will send payments. In one embodiment, each time a project is edited, an explanation is captured summarizing the task that was performed and the reason.

After project managers edit a project timeline, the system may recalculate start and end dates for each phase. In one embodiment, the system checks for gaps and overlaps in the timeline. The system also may determine whether phases are properly ordered. For example, in the example above, a final fix phase should come after aggregation review, final review after final fix, etc. The system may display validation errors to the user. If the edits are successful, project participants who have opted to receive timeline changes are notified, for example, by email or otherwise.

When adding a phase, a project manager specifies the location in the current timeline to place the new phase. If a new phase is added, and that type of phase already appears in the timeline, the phase name appears with a number indicating the phase number (e.g., “Registration 2”). In one embodiment, the phases that may be added include registration (default length 72 hours); submission (default length 120 hours); review (default length 24 hours); appeals (default length 12 hours); appeals response (default length 12 hours); aggregation (default length 24 hours); final fix (default length 24 hours); client review (default length 24 hours); and manager review (default length 24 hours). Custom phases also may be configured and added.

The management system also may determine whether phases are properly added or deleted. For example, in one embodiment, phase changes are validated based on rules. Exemplary rules may include the following: (1) each timeline must have submission, review, and final review; (2) beginning phases must be registration or submission; (3) ending phases must be final review, client review, or manager review/approval; (4) registration and submission phases can occur anywhere in the timeline; (5) registration is optional (need not be included) in a project; (6) if registration is present, submission must follow registration; review must follow submission or screening; (6) appeals must follow review; (7) appeals response must follow appeals; (8) appeals and appeals response are optional; (9) aggregation and aggregation review are optional; (10) if aggregation phase is present, aggregation review must follow; (11) if aggregation and aggregation review are present, they must follow appeals response or review; (12) if aggregation and aggregation review are not present, final fix must follow appeals response or review; (13) if final fix is present, final review must follow; (14) approval can occur after any phase.

After phase changes are made, the system may recalculate the start and end dates. In one embodiment, if a change would violate the rules, such as one or more of the exemplary rules above, the change is not made, and an error message is displayed. For example, if a deletion would violate the rules, the phase is not removed from the timeline, and an error message displays the reason for non-deletion.

In one embodiment, the criteria for a phase to start may be configured. The default for each phase to start is at the end of the previous phase, but this date may be modified. For example, start criteria may include: when previous phase ends; when previous phase begins (if valid); when another phase ends (with a selection of possible phases); when another phase begins (with a selection from possible phases); and a specified date/time. A lag time (e.g., days or hours) may be set relative to phase begin criteria so that there is some time delay between, or overlap between phases. The lag time may be positive (time delay) or negative (overlap), although negative may not make sense in all cases, for example, when the end time of a phase is not determinable in advance.

In one embodiment, the criteria for a phase to end may be configured. The administrator or project manager may edit default end dates for any phase. If phase end dates are modified, phase duration will change. After editing the duration, the system may recalculate the start and end dates for each phase. In one embodiment, the end date for a phase is validated according to rules. An exemplary rule is that the phase end date must come after the phase begin date for that phase. Registration and submission phases may have specific end criteria that may be set. For example, in one embodiment, the administrator or project manager may specify the number of registrations or submissions required to end a registration phase.

As another example, manual screening may be required for submission, and if manual screening is required, the duration for manual screening may be specified. In one embodiment, the default duration for manual screening is 24 hours. For example, screening may not be marked late if it is completed within the set duration.

In some embodiments, project managers may manually change the current phase for a project. In one embodiment, validation ensures that the project is allowed to enter the new state. For example, projects may not be moved to completed phases. In one embodiment, only valid phases are displayed as options for movement. In one embodiment, a project can not be moved to a new phase without required preconditions for the current phase being completed.

In some embodiments, an administrator or project manager may change the project status. For example, project status may be changed to “failed screening,” “failed review,” “completed,” “failed (zero submissions),” and so on, and the reason for the status change captured. In one embodiment, after setting the project status to “failed review” or “completed,” an administrator or project manager views a confirmation screen with a “send payment” button, that links to a payment system.

In one embodiment, administrators, project managers, project participants, and/or other users may request to receive timeline change notifications. The notifications may be email, text message, etc. All project participants may receive such notifications by default.

In one embodiment, managers may view information about payments made to project participants, including the payment details, and whether payment has been sent. Likewise, in one embodiment, a user may view each payment due to be made to her, and whether payment has been sent.

In one embodiment, while a user is viewing project details, the user may choose to contact users with a manager role. The user may enter a text message. After the message is sent, the user may be notified and have the option to return to the project details page, send another message, or return to their project list.

In one embodiment, users with a project manager or observer roles are allowed to view registrations during the registration phase. The user may select a project for which they wish to view registrations, and view, for each user who has registered, such information as the registered users' name or handle (e.g., with a link to more information about the user), a link to email the registered user, rating(s) for the person when they registered (e.g., skill rating, reliability rating, and/or other ratings) and/or other information.

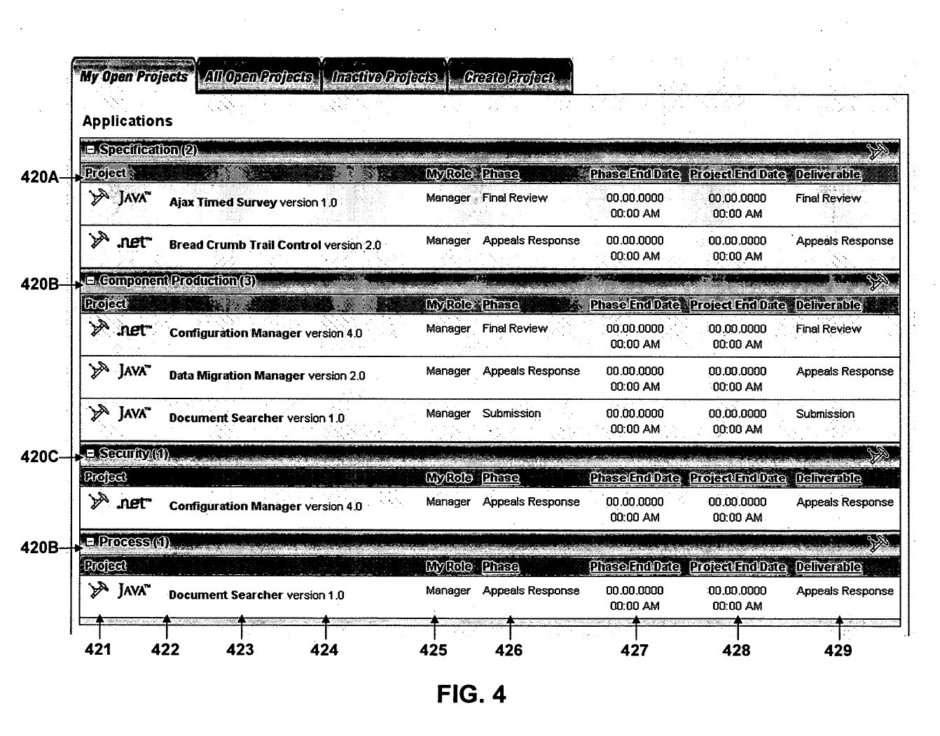

Referring to FIG. 4, in one embodiment, the management system provides a user with a display of all active projects. The projects may be organized by type, category, sponsor, and/or other criteria. In one embodiment, projects that are late are visibly distinguishable from other projects, for example, by color of display and/or other indicia. In one embodiment, projects that are almost late (e.g., within 1 day of being late) also are visibly distinguishable from other projects.

Using this demonstrative example of a display, a project participant may view information about the projects to which he or she is assigned. In this way, a project participant can view the projects that he or she is involved with, and determine what upcoming work will be needed. The same format may be used for a manager or administrator to look at all projects.

In this exemplary display, the projects are organized by type, for example, Specification 420A, Component Production 420B, Security 420C, and Process 420D. Information about a project includes the stage of the project (indicated by a symbol) 421, the catalog of the project 422 (e.g., Java or .Net), the project name 423 and version 424, the role of the viewer 425, the current phase 426, the end date of the current phase 427, the end date of the project 428, and the currently required deliverable(s) 429. In other embodiments, other project details may be provided.

In one embodiment, this type of project view is available to all users, but may or may not include all of the information provided. In one embodiment, unless a project is private, all information is available to all users. For example, it may include the name of the project, the version of the project, a link to the project description, a link to the project discussion board, a high-level timeline that includes any individual project timelines, notes regarding the project, the role(s) of the person viewing the project, outstanding deliverables for the project, dates for any outstanding deliverables, deliverable(s) for the user viewing the project and their associated dates, scorecards for the project, and a mechanism to send a message to project management.

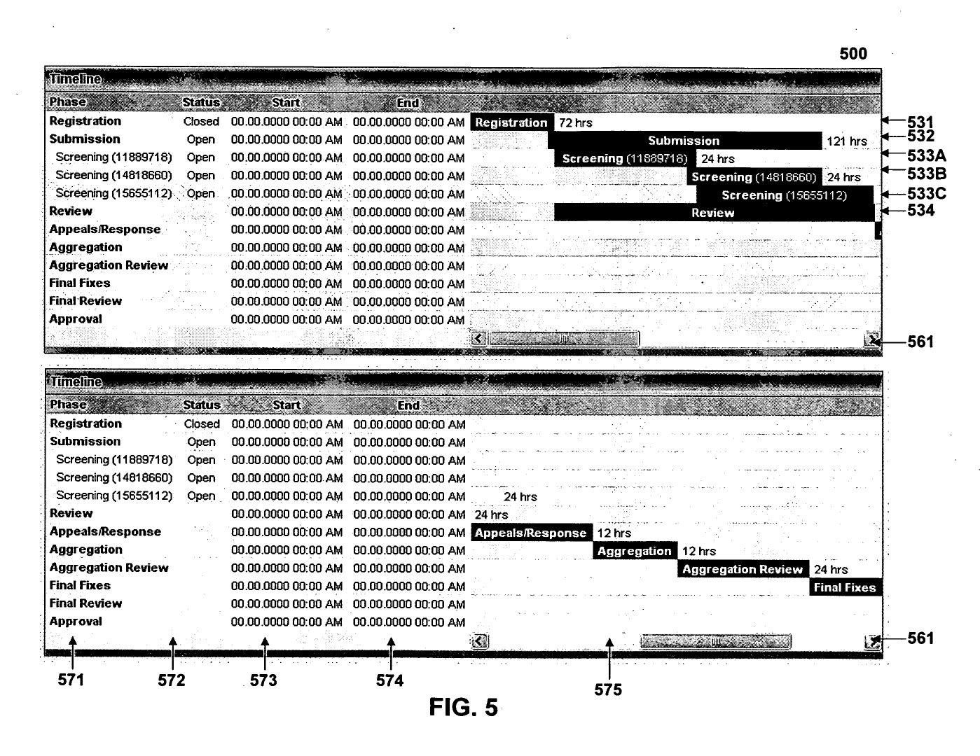

Referring to FIG. 5, in one embodiment, users may view a project timeline 500 in a graphical format. Timeline phases (e.g., phases 531-534) display in a graphical format in relation to other phases. In this embodiment, each of the phases is presented in a separate row. Thus, registration is shown in a first row 531, submission is in a second row 532, screening is shown in three rows 533A, 533B, and 533C (because a separate screening phase is initiated for each submission), and review is shown as another row 534. In this implementation, moving the scroll bar 561 allows viewing of additional timeline information related to additional phases, as shown in the bottom view.

In this example, for each phase, the following information is presented: the phase name 571, phase status 572 (e.g., open—current in progress, closing—within X number of days/hours from end date (configurable), closed—all deliverables completed, and late—phase end date has passed, but deliverable is not complete), actual start date/time 573, and actual end date/time 574. The original start date and original end date (not shown) also may be included.

A graphical timeline 575 depicts the relative timing of the phases, with the duration indicated.

In one such embodiment, the registration status of a project is displayed based on the colors associated with the participants who have registered. For example, if participants have an associated rating, a registration status may be displayed as red (e.g., a problem) if no members of sufficient rating have registered, and yellow (e.g., caution) if some members of a medium rating have registered. For example, if participants are rated as Red, Yellow, Blue, Green, and Gray (in order from best to worst), the display may show phase color as red if no red, yellow or blue members have signed up, and show phase color as yellow or blue if as least one blue member has signed up. Such a display may facilitate the management of a contest-based development methodology by showing clearly the status of the various phases of a project.

Scorecards

In one embodiment, using the system, a project administrator may create and manage one or more scorecards. Specification of a scorecard may include specification of such parameters as a name of the scorecard, a version number of the scorecard, a project type and category, a scorecard type, a minimum acceptable score and a maximum acceptable score. In one embodiment, the version number of a scorecard is automatically incremented when the scorecard is modified.

Scorecard types may include, for example, screening scorecards, review, client review, and custom. Additional types may be provided.

In one embodiment, a project administrator may create one or more question groups for a scorecard. The question group may be specified by a name and a weight. The weight designates the analytical weight that is given to that group.

Each question group may include one or more sections that, in turn, may be specified by a name and a weight. Each section may include one or more scorecard questions. Questions may include, for example, question text, guidelines for answering the question, the weight to be given to the question within the section, the type of question (e.g., scale 1-4, scale 1-10, test case percentage, yes/no, dynamic), specification of whether document upload is allowed, and if it is allowed, whether a document is required. A dynamic question may be generated dynamically based on an XMI description document. Thus, the general format of a scorecard may be specified, with question content specified in a description document. In one embodiment, the scoring on a scorecard with respect to test cases is the percentage of passed test cases out of the total test cases.

In one embodiment, numbering is displayed for the scorecard in the format X.Y.Z where X is the group number, Y is the section number and Z is the question number.

Administrators may change the order of questions for display. In one embodiment, running totals for questions and sections are displayed during scorecard creation. In one embodiment, scorecards are validated to determine that the questions within a section add up to 100%, and sections within a group add up to 100%. A scorecard may be validated, such that if a scorecard is not properly formed, an error message may display. Likewise, the system may determine whether the scorecard name and version is a unique combination.

Existing scorecards may be viewed and/or edited. In one embodiment, scorecards that have been used in a project may not be edited, but rather a copy may be edited. Typically, an administrator may not edit the name or version of a scorecard, but other details may be edited, including adding, deleting, or modifying groups, sections, and/or questions. In one embodiment, each time a scorecard is edited, the minor version number is incremented.

In one embodiment, administrators and/or project managers are allowed to view the list of scorecards. Scorecards may be displayed, for example, according to project type, project category and scorecard type. Scorecards may be filtered by status. A user (e.g., a project manager or administrator) may select a scorecard to view. Scorecards may be displayed in a read-only view, such as they will appear to a user completing the scorecard.

In one embodiment, the system allows users to download review scorecards and complete them offline. When a user returns online they may upload the completed scorecard.

Submission Phase

During a submission phase, users may submit submissions. In typical embodiments, only users with a submitter role may be allowed to submit. Submissions may be accomplished by any suitable means. In one embodiment, submissions are accomplished by uploading the submissions to the system.

If the submission phase is configured for automatic screening, automatic screening results are displayed after each submission. Automatic screening may include screening using zero or more specified rules.

In one embodiment, the system tracks each user's submissions, and assigns each submitter a unique ID for each project to which they submit solutions. For example, if user Bob submitting for projects Y and Z may be assigned “Submitter 1500” for project Y and “Submitter 1501” for project Z, but if user Bob submits a correction for project Y, he is still designated “Submitter 1500” and the file provided by Bob stored accordingly. The ID's are unique system-wide, and submitters are referred to by this ID through the application process to maintain their anonymity during review. Communication may take place, for example between project managers and submitters, using a communication mechanism, such as a bulletin board, that maintains the anonymity of the submitter.

If manual screening is configured, submissions are not complete until the submission passes manual screening, and only submissions that pass manual screening will be passed to review. Manual screening results are provided to the submitter, and may be available to all users.

Project managers may see all submissions, including past submissions from submitters. Submissions are displayed in each applicable phase of a project. In one embodiment, submissions are sorted by submission ID. Submissions that have deliverables that are late may be visibly distinguishable from other submissions. Submissions that have deliverables that are almost late (e.g. 1 day from being late or other configurable value) may be visibly distinguishable from other submissions. In one embodiment, information about submissions that may be provided includes a submission identifier (e.g., a link to download submission), the name and/or handle of the submitter (which may be displayed with a color indicative of the rating of the submitter), a submission status that identifies when a submission has a deliverable that is late or near late, the date of submission, a link to automatic screening results, a list of previously submitted projects per user, sorted by most recently uploaded.

In one embodiment, submitters are allowed to view all of their submissions. Submissions are displayed in each phase of the project, sorted initially by submission id. Submissions that have deliverables that are late or almost late may be distinguishable from other submissions.

Screening Phase

In one embodiment, screeners may view submissions for a project for which they are the assigned screener. In one such embodiment, submissions are displayed when a screener is assigned the submission. Submissions are sorted by submission ID. Submissions that have deliverables that are late or almost late may be distinguishable from other submissions. Information provided about the submissions may include the information described above.

In one embodiment, observers and reviewers may view the most recent submissions from submitters. All users may view details for the winning submission. The winning submission may be announced, for example, after the appeals response phase. Likewise, in some embodiments, it may be possible to view details on all submissions once the appeals response phase is complete.

Administrators and projects managers may remove submissions. In one embodiment, although removed from a project, the submissions will not be deleted from the system.

In one embodiment, screeners and primary screeners are allowed to perform screenings. In one such embodiment, if a primary screener is assigned, he or she is responsible for screening all submissions.

In one embodiment, a screener selects a submission to screen. The screener completes a scorecard. Scorecards may include one ore more question groups, question sections, question texts, and question guidelines. The scorecards may include a rating response, one or more responses to questions. There may be a requirement to complete at least one response for every question. Responses may include text responses, and a description of a requirement, recommendation or other comment.

In one embodiment, scorecards are initially displayed with one or more text response areas, that contain an initial default value (e.g., “comment”). Response descriptions of type ‘comment’ with an empty response are not saved.

Screeners may preview a scorecard before finalizing it. After a screener has completed each screening scorecard, the scorecard is validated. For example, it may be validated to determine whether all questions have answers, and all responses have response text. The user may have the option to save the scorecard before completion, and they may be designated a “pending” status in that case. When a screener is finished screening a submission, he submits the scorecard, and the scorecards are assigned a “complete” status. After the scorecard has been validated the score is computed and displayed.

Users may be allowed to view the screenings for submissions for which they have access to. In one embodiment, information about a screening may include a screening date, name/handle of screener performing the screening, the email address of the screener (which in some cases may be provided only to administrators and/or project managers), the status of the screening, the score of the screening (this may include a link to a completed screening scorecard), the result of the screening (e.g., pass or fail), and whether the submission advances to the next phase.

In one embodiment, submitters may no longer submit after their submission passes screening and enters review.

If an end date is specified for a submission phase, then the submission phase lasts until that date. If manual screenings are required, then the system may check to see if the required numbers of submissions have passed manual screening and auto-screening.

In one embodiment, a submission phase closes when a predetermined number of submissions has passed auto and/or manual screening. All then-received submissions that have passed screening may be passed to review.

If manual screening is not required, the system may check to see if the required number of submissions have been met and passed auto-screening. In one embodiment, the submission phase close when the required number of submissions has passed auto-screening. All received submissions are auto-screened and passing submissions are passed to review.

Review Phase

Reviewers may perform reviews for submissions that pass screening. For example, a reviewer may select a submission and be presented with a review scorecard for completion.

In one embodiment, each reviewer completes a review scorecard for each submission during the review phase. Again, each scorecard may contain one or more question groups, one or more question sections, text for each question, a rating response, and/or one or more responses to questions, for example, with at least one response for each question, where a response may be a text response or requirement, recommendation, or other comment.

In one embodiment, if reviewers have completed all scorecards, but have not submitted the scorecards by the time that a specified deadline for the end of the review process is reached, scorecards are submitted (if they pass validation). Scorecards initially may be displayed with 3 text response areas, with a default response description of comment. Response descriptions of type ‘comment’ with an empty response are not saved.

In one embodiment, when complete, a scorecard is saved to a database. If a reviewer saves a scorecard without submitting, the scorecard status is displayed as “pending”. After submission, the scorecard status is changed to “complete”.

After a scorecard has been finalized, the score is automatically computed by the system (e.g., according to a configured weighted matrix) and displayed.

Reviewers may upload supporting documentation or quality tests to verify the quality submission. For example, a reviewer may submit blueprints or scanned images that reflect the quality of the submission, or which may be used to test or verify the submission.

With respect to software, a reviewer may submit one or more test cases that may be used to test the submission in the course of a review. The test cases may be uploaded into the system. Thus, in one embodiment, test case reviewers have a pending deliverable until they have submitted a predetermined number of test cases. In one embodiment, test case reviewers are allowed to provide updated test cases until the final fix phase. Test Case Reviewers may upload test cases during review. When test cases are added or modified, reviewers and managers may receive an email notification. In one embodiment, users with manager, observer, submitter, reviewer and approver roles may download test cases that are available on the system.

Users may be allowed to view reviews for submission for which they have access to. In one embodiment, Project Manager, Observer, Submitter, Screener, Aggregator, Final Reviewer, Approver, Public and Designer roles may be allowed to view all reviews from all reviewers for the submissions they have access to. Information regarding the review may include the date the review is completed, the name/handle of the reviewer, a link to reviewer email (which may only be provided to manager/administrators), a status of the review, an average of all review scores (e.g., and a link to a composite scorecard) and a link to the scorecard.

In one embodiment, reviewers are only allowed to view their reviews. Reviewers may be allowed to edit their reviews, if the review phase is not complete.

In one embodiment, a review phase ends if a previous phase has ended and, if the project has test case reviewers (accuracy, stress, or failure), the system determines that all test cases are uploaded, and that all reviews are complete. In such case, the system may advance the project to the next phase.

In one embodiment, the implementation of “on demand” review allows projects to advance to a next phase as soon as review is complete rather than wait for a deadline to pass or for manual action by an administrator.

Appeals Phase

Submitters may be allowed to submit appeals during the appeals phase. The submitter selects the review for which they wish to submit an appeal. The submitter may be allowed to view the relevant scorecard while performing an appeal. The submitter selects a question to appeal, and enters appeal text. Submitters may be required to submit appeals for each question individually.

Users may be able to view appeal activity. In one embodiment, a user can choose the scorecard for which they wish to view appeals. The appeals are displayed for each review as they are submitted. A user is able to view the scorecard with appeals. The appeal text is displayed with each question/response that has an appeal.

In one embodiment, the appeals phase will end if the review phase has ended, and submitters have been given a predetermined amount of time to post appeals. When the required time for appeals has elapsed, the system advances the project to the next phase.

Appeals Response Phase

During the appeal response phase, users with a reviewer role may submit appeal responses for the appeals arising out of their review scorecard. The reviewer may choose the review scorecard for which they wish to perform appeals response, and review the scorecard while performing appeals. Reviewers may enter appeals response text and/or select a modified response. A notification may be provided to the submitter and/or others upon the entering of an appeals response. Reviewers may be allowed to edit their appeal responses during the appeals response phase.

A submitter may then view the scorecard to see the reviewer's response to the appeal. In one embodiment, the appeal and the response may be viewed.

In one embodiment, an Appeals Response phase will end if the Appeals phase has ended, and all appeals have responses. In such case, the system may advance the project to the next phase.

In one embodiment, at the end of an appeals response phase, the review scorecards for each submission are totaled. When all of the scorecard scores are available, the highest score(s) may be identified and winner(s) of a contest (if applicable) may be selected. In one embodiment, the winner is a submission with the highest total score on scorecards following appeals. Project standings may be displayed, as well as the submissions with the top three scores.

In one embodiment, if there is a tie in a component competition, the tied competitors may be evaluated based on all three individual review scores, so that a competitor that places the highest the most times is awarded a victory. For example, if competitor A receives three scores (95, 95, 90) and competitor B receives scores (100, 100, 80), competitor B wins since even with the scores being tied, two individual reviewers awarded her the victory.

Aggregation Phase

In some embodiments, aggregators may perform aggregation of reviews during an aggregation phase. For example, aggregators may aggregate the scores and comments provided during the reviews. Aggregators thus may provide a quality control function as well as an aggregation function. Duplicate comments are eliminated, and a list of required final fixes is collected. This may be accomplished through the use of aggregation scorecards.

Aggregation scorecards may contain comments from individual reviewer scorecards. In one embodiment, the aggregator may specify “rejected,” “accepted” or “duplicate” for each review question response.

In one embodiment, each aggregation scorecard contains a question group, question section, question, reviewer name/handle, question response, aggregator response (text area) response type (required, recommended, comment), aggregate function (rejected, accepted, duplicate).

The aggregator can review a read-only version of an aggregation scorecard. The scorecard may be validated. The scorecard may be saved for later, and assigned a “pending” status; and when it is completed, assigned a “completed” status.

In one embodiment, all roles may view an aggregation scorecard when it is available. Submitter handles are displayed.

Each reviewer reviews the aggregation. Reviewers may reject or approve comments from any scorecard. For each question, the user may be provided with the question (and the group, section, etc.). Each response may include such information as a reviewer handle, comment number, question response text, response type, status, aggregator comments submitter comments, and a review function (e.g., accept or reject) and reviewer comments in the case of a rejection.

In one embodiment, if the reviewers approve the aggregation, they submit the approved aggregation. If any item is rejected, the whole aggregation is rejected, and the reviewer who has rejected items receives a notification of the rejection. If an aggregation is rejected, the system may automatically instantiate a new aggregation and aggregation review phase, the aggregation scorecard will be pre-filled with the latest aggregation information. No phases will be instantiated or emails sent until each aggregation review is submitted.

Users may be allowed to view the aggregated reviews after they are complete.

For example, users who are allowed to view all reviewers reviews may view the composite review for submissions they have access to. The user selects the submission for which they wish to view the composite review. The composite review includes the submission ID, the role for user viewing the scorecard, the name of the scorecard, the group of scorecard questions, the section for the question group, each scorecard question, the average score from all reviewers, the scores from each reviewer, and responses from reviewers.

In one embodiment, the Aggregation phase ends if the Appeals Response phase is complete, and aggregation is complete. In such case, the system moves on to the next phase.

Final Fix Phase

Submitters may submit final fixes for items marked as required in the aggregation scorecard. The submitter may browse for the file to upload and upload their solution. Project Manager, Observer, Submitter, Final Reviewer and Approver roles may download final fixes.

In one embodiment, the final fix phase ends if the previous phase is complete and all final fixes are submitted. In one embodiment, the submitter needs to approve the aggregated scorecard comments.

Final Review Phase

Final reviewers are allowed to perform final review. In one embodiment, the final review scorecard is a result of the aggregation review. In one embodiment, for each question, the final reviewer may see the Final Review Section; Final Review Question; Reviewer Handle; Reviewer Response; Aggregator response; Submitter comment; Reviewer comment; Type (required, comment or recommended); Status (fixed or not fixed); and a final reviewer response text-box. Based on this information, the final reviewers may approve final fixes, and provide comments. The final reviewer may approve or reject the submission.

If the final reviewer does not select “approve final fixes”, the system may confirm that the user intends to submit without approval. If the submission fails final review, the system will automatically instantiate a new final fix and final review phase and switch to the new final fixes phase.

Users may view the final review scorecard when complete.

In one embodiment, submitters may submit comments for items on the aggregation scorecard during aggregation and aggregation review.

In one embodiment, the final review phase ends if the final fix phase has ended, and final review is complete.

Approval Phase

In one embodiment, approval is an optional phase for custom client and manager reviews. Users with the approver role can perform approvals. Approvals may be performed with custom scorecards, or scorecards that are used in other phases. For example, an approval phase may be used where a reviewer and another party (e.g., a client) want to provide feedback.

In one embodiment, the approval phase ends if the previous phase has ended and approval is complete.

Auto Pilot

In one embodiment, a project may be configured with an “auto-pilot” feature that will allow the management system to close a phase that may be closed, and start any phases that may be opened. Phase changes may applied until no changes can be made. In one embodiment, an auto pilot module polls the projects at a configurable interval. In one such embodiment, the interval is every 5 minutes. The auto pilot module is run at each interval and performs checks on the phases as configured.

In one embodiment, the auto pilot change phases only for projects that have the “auto pilot” configuration switched on. In one embodiment, if not enabled for a project, the auto pilot still may provide the project manager with a notification (e.g., email, text message, etc.) that the phase may be changed, but not change it. Phase changes for projects without the option enabled may be changed manually.

In one embodiment, configurable phase handlers may be provided to control the starting and stopping of phases. The phase handlers may be specified when the project phases are configured. When the phase handlers are configured, the auto pilot may change the phases as the conditions specified are met.

In one exemplary embodiment, the following phase conditions are specified:

Registration Phase: Registration phase may start when the start time is reached. Registration may stop when the stop time has passed and a number of registrations meets the required minimum or maximum.

Submission Phase: Submission may start when the start time is reached, and the dependency phases (if any) is complete. Dependency phases are phases that should complete prior to completion of the current phase, and is generally the previous phase. Submission may stop when the proscribed period has passed and if manual screening is not required, the number of submissions that have passed auto-screening meets the required number; and if manual screening is required, the number of submissions that have passed manual screening meets the required number.

Screening Phase: Screening can start as soon as there are submissions. Screening can stop when the dependency phases are stopped; and if manual screening is not required, all submissions have been auto-screened; and if manual screening is required, all active submissions have one screening scorecard committed. When screening is stopping, all submissions with failed screening scorecard scores should be set to the status failed screening.

Review Phase: Review can start as soon as there are submissions that have passed screening. Review can stop when the dependency phases are stopped and all active submissions have one review scorecard from each reviewer for the phase; and all test case reviewers have one test case upload.

Appeals Phase: Appeals can start as soon as the dependency phases are stopped. Appeals can stop when the dependency phases have stopped and when the specified period has passed.

Appeals Response Phase: Appeals Response can start as soon as there are appeals. Appeals Response may stop when the dependency phases are stopped and all appeals are resolved. When Appeals is stopping, all submissions with failed review scorecard scores should be set to the status failed review. Overall score for the passing submissions should be calculated and saved to the submitters' resource properties together with their placements. Submissions that do not win should be set to the status Completed Without Winning. The submission with the highest total score(s) are selected as winner(s). In case of a tie, the submissions are evaluated based on individual review scores. The submission wins the most times will be awarded the victory.

Aggregation Phase: Aggregation can start as soon as soon as the dependency phases are stopped. Aggregation can stop when the dependency phases are stopped and the winning submission has one aggregated review scorecard committed.

Aggregation Review Phase: Aggregation review can start as soon as the dependency phases are stopped. Aggregation review can stop as soon as the dependency phases are stopped and the aggregation scorecard is approved by two reviewers other than the aggregator.

Final Fix Phase: Final fix can start as soon as the dependency phases are stopped. Final fix can stop as soon as the dependency phases are stopped and the final fix has been uploaded, and the aggregation scorecard is approved by the winner.

Final Review Phase: Final review can start as soon as the dependency phases are stopped. Final review can stop as soon as the dependency phases are stopped and the final review is committed by the final reviewer.

Approval Phase Handler: Approval can start as soon as the dependency phases are stopped. Approval can stop as soon as the dependency phases are stopped, and the approval scorecard is committed.

Security Roles and Permissions

In one embodiment, security checks are roll-based, and are validated with permissions. Each function in the system validates a user's permission against the required permission for the task. One or more permissions may be assigned to roles. A user may have more than one role.

Table 1 includes an exemplary list of roles and permissions:

TABLE 1

| | | | | | | | Final | | | | |
|---|---|---|---|---|---|---|---|---|---|---|---|
| | Manager | Observer | Submitter | Screener | Reviewer | Aggregator | Reviewer | Approver | Public | Designer | System |
| Create Scorecard | X | | | | | | | | | | |
| Edit Scorecard | X | | | | | | | | | | |
| View Scorecards | X | | | | | | | | | | |
| Create Project | X | | | | | | | | | | |
| Edit Project | X | | | | | | | | | | |
| Details | | | | | | | | | | | |
| Set Timeline | X | X | X | X | X | X | X | X | | X | |
| Notifications | | | | | | | | | | | |
| View Projects | X | | | | | | | | X | | |
| View My Projects | X | X | X | X | X | X | X | X | | X | |
| View Projects | X | | | | | | | | | | |
| Inactive | | | | | | | | | | | |
| View Project | X | X | X | X | X | X | X | X | X | X | |
| Detail | | | | | | | | | | | |
| View Project | X | X | | | | | | | | | |
| Resources | | | | | | | | | | | |
| View SVN Link | X | X | | | X | X | X | | | | |
| View All Payment | X | X | | | | | | | | | |
| Information | | | | | | | | | | | |
| View My | | | X | X | X | X | X | X | | | |
| Payment | | | | | | | | | | | |
| Information | | | | | | | | | | | |
| Contact Project | X | X | X | X | X | X | X | X | X | X | |
| Managers | | | | | | | | | | | |
| View | X | X | | | | | | | | | |
| Registrations | | | | | | | | | | | |
| Perform | | | X | | | | | | | | |
| Submission | | | | | | | | | | | |
| View All | X | | | | | | | X | | | |
| Submissions | | | | | | | | | | | |
| View My | | | X | | | | | | | | |
| Submissions | | | | | | | | | | | |
| View Screener | | | | X | | | | | | | |
| Submission | | | | | | | | | | | |
| View Most Recent | | X | | | X | | | | | | |
| Submissions | | | | | | | | | | | |
| View Winning | | | | | | X | X | | X | X | |
| Submission | | | | | | | | | | | |
| View Most Recent | | | | | | | | | X | X | |
| after Appeals | | | | | | | | | | | |
| Response | | | | | | | | | | | |
| Remove | X | | | | | | | | | | |
| Submission | | | | | | | | | | | |
| Perform | | | | X | | | | | | | |
| Screening | | | | | | | | | | | |
| View Screening | X | X | X | X | | X | X | X | X | X | |
| Perform Review | | | | | X | | | | | | |
| Upload Test | | | | | X | | | | | | |
| Cases | | | | | | | | | | | |
| Download Test | X | X | X | | X | | | X | | | |
| Cases | | | | | | | | | | | |
| View All Reviews | X | X | X | | X | X | X | X | X | X | |
| View Reviewer | | | | | X | | | | | | |
| Reviews | | | | | | | | | | | |
| View Composite | X | X | X | | | X | | | X | | |
| Scorecard | | | | | | | | | | | |
| Edit My Review | | | | X | | | | | | | |
| during Review | | | | | | | | | | | |
| Perform Appeal | | | X | | | | | | | | |
| View Appeals | X | X | X | | X | | | X | X | X | |
| Perform Appeals | | | | | X | | | | | | |
| Response | | | | | | | | | | | |
| View Appeal | X | X | X | | X | | | X | X | X | |
| Responses | | | | | | | | | | | |
| Edit My Appeal | | | | X | | | | | | | |
| Response during | | | | | | | | | | | |
| Appeals Response | | | | | | | | | | | |
| Perform | | | | | X | | | | | | |
| Aggregation | | | | | | | | | | | |
| View Aggregation | X | X | X | | X | | | X | X | X | |
| Perform | | | | | | X | | | | | |
| Aggregation | | | | | | | | | | | |
| Review | | | | | | | | | | | |
| View Aggregation | X | X | X | | X | | | X | X | X | |
| Review | | | | | | | | | | | |
| Perform Final Fix | | | X | | | | | | | | |
| Download Final | X | X | X | | | | X | X | | | |
| Fix | | | | | | | | | | | |
| Perform Final | | | | | | | X | | | | |
| Review | | | | | | | | | | | |
| View Final | X | X | X | | | | X | X | X | X | |
| Review | | | | | | | | | | | |
| Submit Scorecard | | | X | | | | | | | | |
| Comment | | | | | | | | | | | |
| Perform | X | | | | | | | X | | | |
| Approval | | | | | | | | | | | |
| View Approval | X | X | X | | | | | X | | | |
| Edit Any | X | | | | | | | | | | |
| Scorecard | | | | | | | | | | | |
| End Phase | | | | | | | | | | | X |
| Advance | | | | | | | | | | | X |
| Submission | | | | | | | | | | | |
| Post Deliverables | | | | | | | | | | | X |

As can be seen from TABLE 1, in some embodiments, the roles assigned determines how a user may interact with the system.

System Implementation

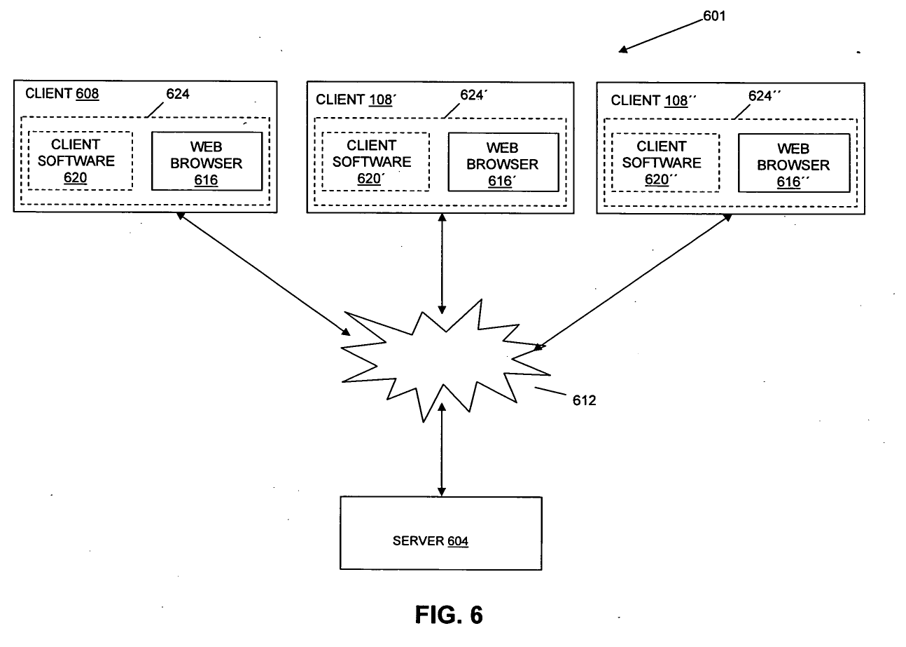

Referring to FIG. 6, in one embodiment, a production management system that implements some or all of the functionality describe here 601 includes at least one server 604, and at least one client 608, 608′, 608″, generally 608. As shown, the system includes three clients 608, 608′, 608″, but this is only for exemplary purposes, and it is intended that there can be any number of clients 608. The client 608 is preferably implemented as software running on a personal computer (e.g., a PC with an INTEL processor or an APPLE MACINTOSH) capable of running such operating systems as the MICROSOFT WINDOWS family of operating systems from Microsoft Corporation of Redmond, Wash., the MACINTOSH operating system from Apple Computer of Cupertino, Calif., and various varieties of Unix, such as SUN SOLARIS from SUN MICROSYSTEMS, and GNU/Linux from RED HAT, INC. of Durham, N.C. (and others). The client 608 could also be implemented on such hardware as a smart or dumb terminal, network computer, wireless device, wireless telephone, information appliance, workstation, minicomputer, mainframe computer, or other computing device that is operated as a general purpose computer or a special purpose hardware device used solely for serving as a client 108 in the distributed software development system.

Generally, in some embodiments, clients 608 can be operated and used by participants to participate in various production activities. Some examples of production activities include, but are not limited to software development projects, graphical design contests, webpage design contents, document authoring, document design, logo design contest, music and song composition, authoring of articles, architecture design projects, landscape designs, database designs, courseware, software design projects, supporting software programs, assembling software applications, testing software programs, participating in programming contests, as well as others. The techniques may be applied to any work product that may be produced by an individual or team, alone or in conjunction with a machine (preferably a computer) by way of a contest. Clients 608 can also be operated by entities who have requested that the designers and developers develop the assets being designed and/or developed by the designers and developers (e.g., customers). The customers may use the clients 608 to review, for example, software developed by software developers, logos designed by graphic artists, user interface designers, post specifications for the development of software programs, test software modules, view information about the contestants, as well as other activities described herein. The clients 608 may also be operated by a facilitator, acting as an intermediary between customers for the work product and the contestants.

In various embodiments, the client computer 608 includes a web browser 616, client software 620, or both. The web browser 616 allows the client 608 to request a web page or other downloadable program, applet, or document (e.g., from the server 604 ) with a web page request. One example of a web page is a data file that includes computer executable or interpretable information, graphics, sound, text, and/or video, that can be displayed, executed, played, processed, streamed, and/or stored and that can contain links, or pointers, to other web pages. In one embodiment, a user of the client 608 manually requests a web page from the server 604. Alternatively, the client 608 automatically makes requests with the web browser 616. Examples of commercially available web browser software 616 are INTERNET EXPLORER, offered by Microsoft Corporation, NETSCAPE NAVIGATOR, offered by AOL/Time Warner, or FIREFOX offered the Mozilla Foundation.

In some embodiments, the client 608 also includes client software 620. The client software 620 provides functionality to the client 608 that allows a contestant to participate in, supervise, facilitate, or observe production activities described above. The client software 620 may be implemented in various forms, for example, it may be in the form of a Java applet that is downloaded to the client 608 and runs in conjunction with the web browser 616, or the client software 620 may be in the form of a standalone application, implemented in a multi-platform language such as Java or in native processor executable code, or the client software 620 may include an asynchronous javascript interface to code running on the server. In one embodiment, if executing on the client 608, the client software 620 opens a network connection to the server 604 over the communications network 612 and communicates via that connection to the server 604. The client software 620 and the web browser 616 may be part of a single client-server interface 624; for example, the client software can be implemented as a “plug-in” to the web browser 616.

A communications network 612 connects the client 608 with the server 604. The communication may take place via any media such as standard telephone lines, LAN or WAN links (e.g., T1, T3, 56 kb, X.25), broadband connections (ISDN, Frame Relay, ATM), wireless links (802.11, bluetooth, etc.), and so on. Preferably, the network 612 can carry TCP/IP protocol communications, and HTTP/HTTPS requests made by the web browser 616 and the connection between the client software 120 and the server 104 can be communicated over such TCP/IP networks. The type of network is not a limitation, however, and any suitable network may be used. Non-limiting examples of networks that can serve as or be part of the communications network 612 include a wireless or wired Ethernet-based intranet, a local or wide-area network (LAN or WAN), and/or the global communications network known as the Internet, which may accommodate many different communications media and protocols.

The server 604 interacts with clients 608. The server 604 is preferably implemented on one or more server class computers that have sufficient memory, data storage, and processing power and that run a server class operating system (e.g., SUN Solaris, GNU/Linux, and the MICROSOFT WINDOWS family of operating systems). Other types of system hardware and software than that described herein may also be used, depending on the capacity of the device and the number of users and the size of the user base. For example, the server 604 may be or may be part of a logical group of one or more servers such as a server farm or server network. As another example, there could be multiple servers 604 that may be associated or connected with each other, or multiple servers could operate independently, but with shared data. In a further embodiment and as is typical in large-scale systems, application software could be implemented in components, with different components running on different server computers, on the same server, or some combination.

In various embodiments, the server 604 and clients 608 may or may not be associated with the entity requesting the production of the work product.

In some embodiments, the work product being produced is an aesthetic design. Generally, an aesthetic design is a representation of a decorative, artistic and/or technical work that is created by the designer. For example, the design can be a graphic design, such as a logo, a graphic, or an illustration. The design can be a purposeful or inventive arrangement of parts or details. For example, the design can be the layout and graphics for a web page, web site, graphical user interface, and the like. The design can be a basic scheme or pattern that affects and controls function or development. For example, the design can be a prototype of a web page or pages, a software program or an application. As another example, the design can be a product (including without limitation any type of product, e.g., consumer product, industrial product, office product, vehicle, etc.) design or prototype. The design also can be a general or detailed plan for construction or manufacture of an object or a building (e.g., an architectural design). For example, the design can be a product design.

In one embodiment, the design is a logo that an individual, company, or other organization intends to use on its web site, business cards, signage, stationary, and/or marketing collateral and the like. In another embodiment, the design is a web page template, including colors, graphics, and text layout that will appear on various pages within a particular web site.

In one embodiment, the work product is a requirements specification for a software program, including the requirements that the program must meet and can include any sort of instructions for a machine, including, for example, without limitation, a component, a class, a library, an application, an applet, a script, a logic table, a data block, or any combination or collection of one or more of any one or more of these.

In instances where the work product describes (or is) a software program, the software program can be a software component. Generally, a software component is a functional software module that may be a reusable building block of an application. A component can have any function or functionality. Just as a few examples, software components may include, but are not limited to, such components as graphical user interface tools, a small interest calculator, an interface to a database manager, calculations for actuarial tables, a DNA search function, an interface to a manufacturing numerical control machine for the purpose of machining manufactured parts, a public/private key encryption algorithm, and functions for login and communication with a host application (e.g., insurance adjustment and point of sale (POS) product tracking). In some embodiments, components communicate with each other for needed services (e.g., over the communications network 612). A specific example of a component is a JavaBean, which is a component written in the Java programming language. A component can also be written in any other language, including without limitation Visual Basic, C++, Java, and C^{#}.

In one embodiment, the work product is an application that, in some cases, may be comprised of other work product such as software components, web page designs, logos, and text. In one embodiment, the software application is comprised of work product previously produced using the methods described herein. In some embodiments, the application comprises entirely new work product. In some embodiments, the application comprises a combination of new work product and previously produced work product.

It should be understood that the methods and systems described here may be used for the development of software, and are particularly suited for the contest-based development of software from software components. The ability to specify and manage contest phases facilitates the simultaneous development of multiple components, while at the same time allowing for the management of an overall project with which the components will be used. The methods and systems also may be used in the development of other types of work product, including graphics and design.

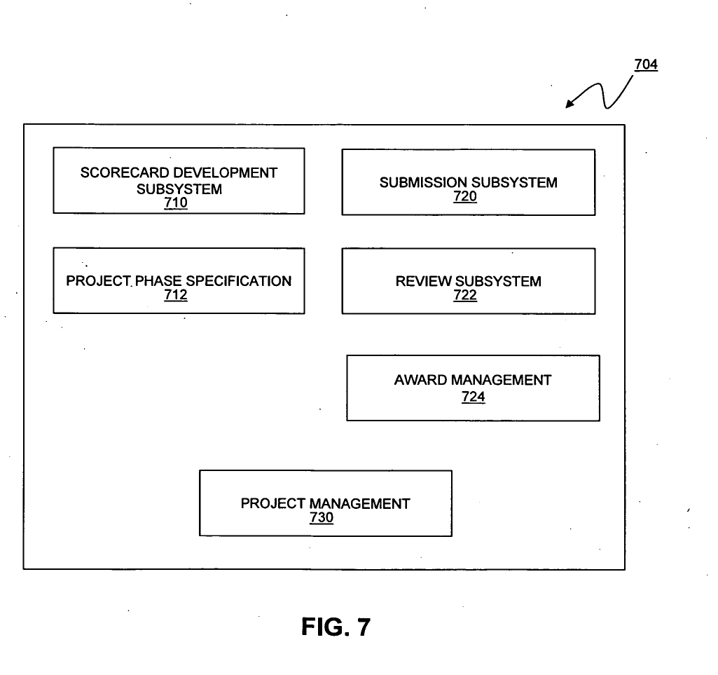

Referring to FIG. 7, a contest-based development management system 704 includes a scorecard development subsystem 710. The scorecard development subsystem facilitates development and storage of scorecards. A project phase specification subsystem 712 facilitates the specification of phases that are included in a project, including scorecards that may be associated with a phase. Phases may be configured to start and end based on date/time specifications and/or based on the occurrence of events, such as receipt of submissions, having submissions that have passed screening, and so forth.

A submission receiving subsystem 720 facilitates submission of submissions by participants. In some cases, the submissions are screened by a screening subsystem (not shown) upon submission. A review and scoring subsystem 722 facilitates scoring of received submissions during a specified project phase using developed scorecards. This subsystem manages the review and scoring of submissions. An award management subsystem manages awards granted to submitters based on the results specified by the scoring subsystem.

A project management subsystem 730, which may be part of or separate from the project phase specification subsystem 712, allows for viewing of project status, and understanding where problems have occurred.

A method for contest-based development that may be implemented by such a system may include facilitating development and storage of scorecards, facilitating specification of project phases, receiving submissions during one or more of the project phases, facilitating scoring of received submissions during a specified project phase using developed scorecards, and managing awards granted to submitters based on the results specified by the scoring subsystem. Additional steps also may be included as described herein.

We claim:

1. A method for managing a project, comprising:
facilitating selection of a template for a project, the template comprising a number of project phases, the project phases comprising a submission phase and a review phase;
receiving configuration for the phases of the project, the configuration comprising designating a start time for a first phase of the project and adding a second review phase to the project;
automatically starting the project at the start time of the first phase of the project;
providing the status of the project upon request; and
automatically starting the added phase when previous phases have completed.

2. The method of claim 1, wherein the project is a production contest.

3. The method of claim 2, wherein the project is a production contest for the production of a software component.

4. The method of claim 2, wherein the project is a production contest for the production of a software application.

5. The method of claim 1, further comprising receiving submissions.

6. The method of claim 4, wherein the step of providing status comprises providing information about deliverables due.

7. The method of claim 1, further comprising, during the review phase, facilitating the completion of scorecards.

8. The method of claim 6, wherein the scorecards are transmitted to a users' computer, completed on the users' computer, and received from the users' computer.

9. The method of claim 6, wherein the scorecards are completed on-line.

10. The method of claim 1, further comprising, during the added phase, facilitating completion of scorecards.

11. A method for conducting a production competition, comprising:
facilitating creation of a scorecard comprising questions and question types;
storing the created scorecard;
facilitating specification of a review phase, the review phase configured to require completion of the created scorecard;
facilitating specification of a project, the project configured to include the specified review phase;
receiving submissions from submitters;
upon receipt of the submissions, making the scorecards available electronically to reviewers for completion during the review phase.

12. The method of claim 11, wherein the scorecard comprises groups of questions.

13. The method of claim 11, wherein the method comprises facilitating creation of two or more scorecards, and the two or more scorecards are each completed by reviewers during the review phase.

14. The method of claim 11, wherein the submissions are assigned an identifier such that the identity of the submitter is not revealed to reviewers.

15. The method of claim 11, wherein the submissions are manually screened to assure formal compliance with submission rules.

16. The method of claim 11, wherein the submissions are automatically screened for formal compliance with submission rules.

17. The method of claim 16, wherein the review phase begins upon successful automatic screening of a submission.

18. The method of claim 11, wherein an aggregation phase is configured following the review phase.

19. The method of claim 11, wherein the production competition is for the development of a software component.

20. The method of claim 11, wherein the production competition is for the development of a graphic design.

21. A contest-based development management system, comprising:
a project phase specification subsystem;
a submission receiving subsystem;
a scorecard development subsystem;
a scoring subsystem for facilitating scoring of received submissions during a specified project phase using developed scorecards; and
an award management subsystem for managing awards granted to submitters based on the results specified by the scoring subsystem.

22. The system of claim 21 wherein the project phase specification subsystem facilitates specification of criteria for ending phases prior to a specified end date/time.

23. The system of claim 22, wherein the criteria comprise submission of specified deliverables.

24. The system of claim 22, wherein the criteria comprise successful passing of automatic screening.

25. The system of claim 22, wherein the project phase specification subsystem facilitates specification of a scorecard for use in a project phase.

26. The system of claim 21, wherein the submission receiving subsystem facilitates uploading of submissions.

27. The system of claim 21, wherein the submission receiving subsystem comprises a screening subsystem.

28. The system of claim 21, wherein the submission receiving subsystem facilitates the submission of submissions such that the identity of the submitter is not known to a reviewer.

29. The system of claim 21, wherein the scorecard development subsystem facilitates development and storage of scorecards.

30. The system of claim 21, wherein the award management subsystem provides information about awards that are due and awards that have been sent.

31. A contest-based development management method, comprising:
facilitating development and storage of scorecards;
facilitating specification of project phases;
receiving submissions during one or more of the project phases;
facilitating scoring of received submissions during a specified project phase using developed scorecards; and
managing awards granted to submitters based on the results specified by the scoring subsystem.

32. The method of claim 31 wherein facilitating specification of project phases comprises facilitating specification of criteria for ending phases prior to a specified end date/time.

33. The method of claim 32, wherein the criteria comprise submission of specified deliverables.

34. The method of claim 31, wherein the criteria comprise successful passing of automatic screening.

35. The method of claim 31, wherein the project phase specification comprises facilitating specification of a scorecard for use in a project phase.

36. The method of claim 31, wherein the step of receiving submissions further comprises facilitating uploading of submissions.

37. The method of claim 31, wherein the method further comprises screening the submissions.

38. The method of claim 31, wherein receiving submissions comprises facilitating the submission of submissions such that the identity of the submitter is not known to a reviewer.

39. The method of claim 31, wherein managing awards comprises providing information about awards that are due and awards that have been sent.
